(19) United States
(12) Patent Application Publication
(10) Pub. No.: US 2009/0090078 A1
(43) Pub. Date: Apr. 9, 2009

(54) COMBINATION PIPE TEST CAP AND CONCRETE SLEEVE

(75) Inventors: KENNETH L. SMART, CALDWELL, ID (US); TERRY K. TIDWELL, PARMA, ID (US)

Correspondence Address: DYKAS, SHAVER & NIPPER, LLP, P.O. BOX 877, BOISE, ID, 83701-0877, US

(73) Assignee: Freedom Inc., Parma, ID (US)

(21) Appl. No.: 11/867,365

(22) Filed: Oct. 4, 2007

(51) Int. Cl. F16L 55/115

(52) U.S. Cl. 52/301; 52/741.3

(57) ABSTRACT

A combination pressure test cap for riser pipe and protective sleeve for protecting the riser pipe as it extends through a concrete slab, the test cap and the protective sleeve releasably connected together through use of a breakable connection.

### FIELD OF THE INVENTION

The invention relates to generally to plumbing, and more particularly to plumbing system pressure test caps and devices for protecting vertical stand pipes as they extend through a concrete slab.

### BACKGROUND OF THE INVENTION

When plumbing systems are installed at a job site, typically a portion of the plumbing system extends through a concrete slab, such as the floor of a basement. Thus, once the concrete slab is poured, the plumbing system extending through the slab or under it is much more difficult to modify and/or repair. As such, under code, portions of the plumbing system are assembled before the concrete slab is poured and portions are pressure tested to ensure that all of the connections are appropriately made. Once the pressure testing has confirmed that the plumbing system is appropriately sealed, then the vertical riser (and other) pipes will be back filled around, appropriately compacted, fine graded and concrete poured to form the slab. To wit, a number of different vertical risers of pipe will extend from the ground surface which will later have fittings attached to them or connected to additional portions of the plumbing system which extend throughout the building.

For testing, vertical risers are traditionally capped (sealed) through a number of common methods/devices. A first method/device is using a rubber cap with a hose clamp fastener that is mechanically tightened on the end of the pipe so as to form a seal. While this device works well, the cost of the devices dictate that after testing takes place, the plumber return to each of the pipes to loosen and reclaim the rubber caps/hose clamp fasteners for reuse on a different installation project, thereby increasing labor cost.

A second type of pipe cap is what is referred to as a “test cookie,” typically a saucer shaped, thin plastic piece which is glued onto the end of the vertical riser thereby sealing it. After testing, the portion of the pipe attaching to the test cookies can be cut off and discarded or the test cookie itself can be chiseled or otherwise broken off. Because of their nature and manner of construction, test cookies are prone to breakage and/or leakage and are typically configured in a way that makes applying adhesive for sealing and attaching them to the vertical riser a very messy process.

After the testing process, the riser pipe must be further handled during the plumbing installation process. This handling takes place prior to the pouring of the concrete, namely the vertical riser pipes extending upwards through the concrete slab (not yet poured) must be “sleeved.” The sleeving process is done, per code requirements, to protect the pipe itself as concrete expands.

The prior art shows a number of different types of such sleeves or emplacement formers, for instance U.S. Pat. No. 5,347,786 to Hodges, U.S. Pat. No. 3,800,486 to Harvey, U.S. Pat. No. 5,099,887 to Hooper, U.S. Pat. No. 3,048,911 to Almon, and U.S. Pat. No. 2,021,472 to Gerriets.

While the prior art shows that other inventors have invented physical devices for use in the sleeving process (or for forming a space into which plumbing can extend), typically plumbers utilize much more inexpensive and crude ways of wrapping pipe (provided that local codes permit such materials), including but not limited to: wrapping the pipe with tape, cardboard, foam (e.g., sill plate foam, plumber's plastic foam), fiberglass building insulation, carpet padding scraps, etc. Obviously, when an individual must return after pressure testing, back filling and compacting to the vertical risers and physically wrap them or otherwise sleeve them to protect them from damage, labor is expended.

Due to the additional labor required, what is desired is a way to economically solve one or both of these problems (test caps, concrete sleeves) within a single device that greatly saves on labor expenses while being easy to use. Embodiments of the present invention solve one or more of these problems.

### SUMMARY OF THE INVENTION

One embodiment of the present invention is a construction element for use in the testing and protection of a riser pipe extending through a concrete slab. Such a riser pipe having a vertical portion that extends above ground surface, this vertical portion having a side wall that terminates in an open top end. The riser pipe also having an external surface.

The construction element comprising a spacer sleeve, a sealable pressure cap and a connector. The spacer sleeve is used to protect a portion of the side wall while a concrete slab is formed. The spacer sleeve being generally tubular in shape, having an open first end and an open second end. The spacer sleeve defining a passageway there through defined by an interior surface. This passageway is configured for slidingly receiving the riser pipe therein.

The pressure cap is for sealing the riser pipes open top end. Preferably, this sealable pressure cap comprises at least one annular flange that is configured for providing a sealing surface when the sealable pressure cap is sealed to the open top end of the riser pipes. In a second embodiment, a pair of concentric annular flanges extends from the cap, thereby allowing the cap to be used to seal two different diameters of riser pipe. Preferably, an adhesive would be used to seal the pressure cap to the riser pipe rim.

The connector is for connecting the sealable pressure cap to the spacer sleeve, this connector being configured for breaking.

Wherein after the riser pipe that is capped by the sealable pressure cap is pressure tested, a user can break the connector connecting the spacer sleeve to the pressure cap thereby detaching the spacer sleeve and allowing it to be slid down the riser pipe to the ground surface. The user would then be able to position the spacer sleeve for concrete slab formation there around. It is preferred that the connector comprises a strip of plastic having a first end adhered to the sealable pressure cap and second end adhered to the spacer sleeve.

It is preferred that the spacer sleeve passageway comprise a concentric flange, this concentric flange defining an aperture there through, generally the diameter of the riser pipe. It is preferred that this concentric flange comprise at least one perforation allowing a portion of the concentric flange to be removed. It is preferred that this perforation be generally circular so that the portion removed is ring shaped. It is also preferred that removal of the perforated portion more easily allows a closet flange to be installed on the riser pipe protected by the spacer sleeve.

In another embodiment, the spacer sleeve has at least one perforation defined in a side wall that allows a portion of the sidewall to be torn off. For instance, the portion of the sidewall extending above the upper surface of the concrete could be easily removed.

Still other features and advantages of the present invention will become readily apparent to those skilled in this art from the following detailed description describing preferred embodiments of the invention, simply by way of illustration of the best mode contemplated by carrying out our invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is perspective view of the first embodiment of the present invention.

FIG. 2 is a perspective view of a second embodiment of the present invention.

FIG. 3 is a perspective environmental view of the embodiment of FIG. 1, shown installed on a piece of riser pipe and having the connector broken.

FIG. 4 is a perspective environmental view of the embodiment of FIG. 2, shown installed on a piece of riser pipe and having the connector broken.

FIG. 5 shows a perspective environmental view the embodiment of FIG. 2, shown installed on a larger piece of pipe than what is shown in FIG. 4, with the inner perforation broken, thereby removing a portion of the spacer flange and allowing the embodiment be installed on a length of tubing with a larger diameter.

FIG. 6 shows a side view of the embodiment of FIG. 3, shown installed in concrete with the ground surface there below.

FIG. 7 shows a side view of the embodiment of FIG. 4, shown installed in concrete with the ground surface there below.

FIG. 8 shows a side view of the embodiment of FIG. 5, shown installed in concrete with the ground surface there below.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is an apparatus for the testing and protection of vertical riser pipes, which are fluidly connected together in a plumbing assembly or system. The method of using this apparatus is likewise included in the disclosure herewith.

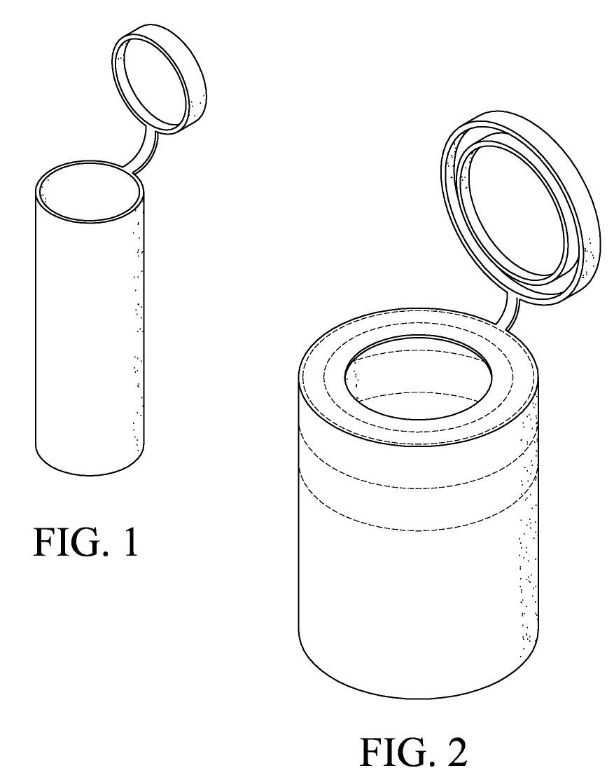

Referring initially to FIG. 1, shown is one embodiment of a combination pipe test cap and pipe concrete sleeve component (hereinafter referred to as construction element 100). This construction element 100 comprising a spacer sleeve 102, which is releasably connected to a sealable pressure cap 104 through use of a breakable connection or connector 106.

The spacer sleeve 102 being a generally tubular piece having an upper end 108 extending to a lower end 110. Preferably attaching adjacent the upper end is the second end of the connector 106. This connector 106 connecting the sealable pressure cap 104 to the spacer sleeve 102. The connector configured for breaking, in example, a perforation could be provided, a weak link could be provided, the plastic could be thin enough that a user could tear/stretch/break it, etc. It is preferably desired that the connecter be configured to allow a user to merely tug or twist upon the spacer sleeve relative to the pressure cap (which at that point is sealingly fixed to the end of the riser pipe) thereby breaking the connection. Alternatively, this connection could be cut or the spacer sleeve could be twisted relative to the sealable pressure cap, thereby resulting in a breakage of the connector. It is preferred that the various components of the present invention be comprised of plastic or similar material, thereby making the connector more suitable for breakable configuration.

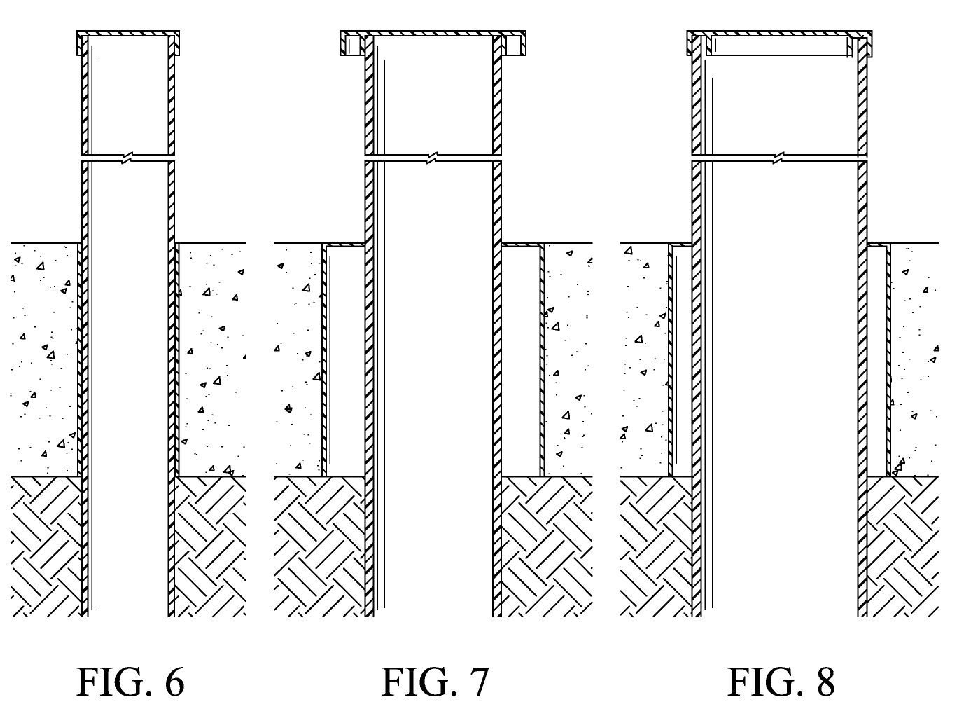

FIG. 1 also showing the sealable pressure cap 104. The pressure cap configured for sealing connection to the open top end of the riser pipe. The pressure cap 104 having an annular flange 112 (shown in FIG. 6), this annular flange configured for engaging the exterior surface 3 of the riser pipe adjacent the riser pipe open end thereby resulting in the covering and/or capping of the open end. It is likewise possible that the annular flange could be configured for insertion into the inside portion of the riser pipe thereby sealing it from the inside instead of the outside. The sealable pressure cap preferably being attached to the riser pipe's open top end through use of a common plumbing adhesive, thereby forming a seal as would be common in plumbing connections.

FIG. 2 shows a second embodiment of the present invention. This embodiment showing a construction element 200 having a spacer sleeve 202 connected through a breakable connection 206 to a sealable pressure cap 204. The spacer sleeve 202 having an upper end 208 extending to a lower end 210. The breakable connection 206 preferably attaching adjacent the upper end 208, breakably connecting the pressure cap 204 to the spacer sleeve 202. As with the embodiment discussed regarding FIG. 1, the breakable connection 206 likewise would be preferably configured for breaking.

This embodiment of spacer sleeve 202 having a concentric spacer flange 214 defined at or adjacent the upper end 208 of the spacer sleeve 202. The spacer flange 214 for maintaining the upper end of the spacer sleeve 202 appropriately spaced apart from its relationship with the riser pipe that extends there through. Preferably, this spacer flange is concentric to the spacer sleeve.

It is preferred that this concentric spacer flange 214 be provided with a plurality of perforations there through, for instance the inner perforation 216 and the outer perforation 218. It is preferred that the perforation(s) be concentric with the aperture 228. The aperture 228 preferably configured for receiving the riser pipe there-through, as shown in FIG. 7. It is preferred that the inner perforation 216 be generally circular and concentric with the aperture 228. The embodiment of FIG. 2 showing an aperture 228 sized to receive a first size of pipe there through (e.g., three-inch PVC pipe) (as shown in FIG. 7) and by removal of the inner perforation 216 and the portion defined thereby, a new aperture 328 (shown in FIG. 5) would thereby be defined allowing a second size of pipe (e.g., four-inch PVC pipe) to extend there-through (as shown in FIG. 8). The outer perforation 218 being removable or at least portions thereof being removable for various purposes, including but not limited to allowing a plumbing fixture (e.g., closet flange) to be installed therein upon the riser pipe. It is not uncommon for plumbing fixtures such as closet flanges to have bulges or diagonal extensions within their external surfaces which need to be accommodated for in such a concrete sleeve. The perforations allow the present invention to more easily be configured for use with a variety of fixtures later applied to the riser pipe.

The embodiment of FIG. 2 (and FIGS. 4-5) also shows a plurality of sidewall perforations, namely an upper sidewall perforation 220 and a lower sidewall perforation 222. Such perforations allowing a portion of the spacer sleeve 202 to be torn or otherwise removed therefrom dependent upon a particular installation of the present invention. For instance, if the concrete slab poured ended up not being as deep as originally expected, the portion of the spacer sleeve 202 extending above the concrete slab's upper surface could more easily be removed.

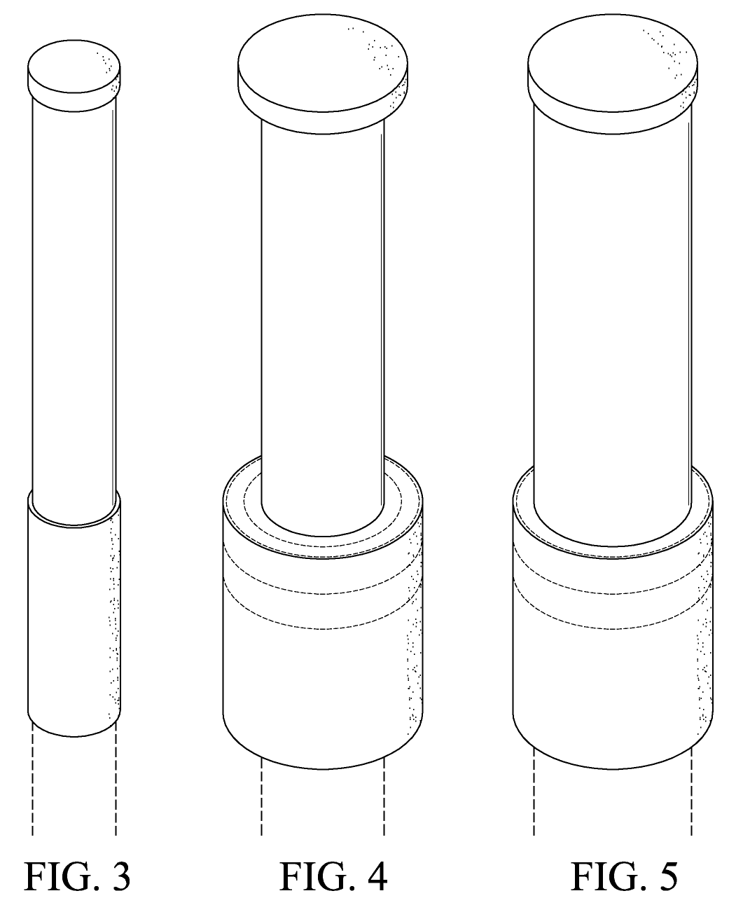

FIG. 3 shows the embodiment of FIG. 1 installed upon a riser pipe 2, having a sidewall 3. This riser pipe having a first open top end (which is not visible because the sealable pressure cap 104 is sealingly connected thereto). This figure also showing that the breakable connection between the spacer sleeve 102 and the sealable pressure cap 104 has been broken, allowing the spacer sleeve 102 to be slid down the sidewall/external surface 3 of the riser pipe 2 to abut a ground surface 9 upon which a concrete slab 8 having an upper surface 14 is formed.

Most plumbing installations in the United States utilize as pipe extending through concrete slabs either two-inch, three-inch or four-inch pipe. The embodiment of FIG. 3 (and FIG. 6) shows one embodiment of the present invention as it relates to two-inch pipe, the embodiment of FIG. 4 (and FIG. 7) shows one embodiment of the present invention as it relates to three-inch pipe. FIG. 5 (and FIG. 8) shows one embodiment of the present invention as it relates to four-inch pipe. While these various embodiments are shown directed towards those particular dimensions, obviously embodiments of the present invention could be created which work with various types of forms, lengths and sizes of pipe and related structure, whether that be outside diameters of pipe other than two, three or four-inch, or whether that be providing an embodiment providing an embodiment similar to what is shown in FIG. 3 for use with a pipe other than the diameter of two inches. For instance, providing an embodiment like what is shown in FIG. 3 which is configured for use on four-inch pipe without the need of removable perforations as is shown in FIG. 5's embodiment. All of these renditions are considered part of the disclosure of the present invention.

Referring now to FIG. 6, shown is a partial, cross-sectional, side view of the embodiment of FIG. 3 (as it would look if installed), showing the riser pipe 2 having a side wall 3 extending through concrete 8 and a soil or ground surface base 9. As can be seen in this drawing, at least a portion (preferably all) of the side wall 3 is protected by the spacer sleeve 102 as it extends through the concrete 8. The open top end 20 is shown sealingly closed by the attached sealable pressure cap 102. This sealable pressure cap 102 having an annular flange 112 extending downwards there from, having an internal surface which sealingly connects to the external surface 3 of the open top end 20, preferably through use of an adhesive.

Referring now to FIG. 7, shown is a side view of the embodiment of FIG. 4 (as it would look installed) shown installed with the riser pipe extending through the ground 9, through concrete slab 8, having a top surface of 14 and extending upwards there from. The spacer sleeve 202 embedded within the concrete 8. The spacer sleeve, through use of the concentric spacer flange 214 defining there between a protective space 224. As can be seen in the relationship between this figure and the embodiment shown in FIG. 6, this protective space is not necessary (nor a required element of the present invention) under the code, for instance merely wrapping the pipe with tape or cardboard strips is enough to satisfy the code, however creating such a protective space is an additional feature of the present invention. Riser pipe 4 having an outer surface 5 which is configured for generally abutting the concentric spacer flange 214. While the spacer flange in the embodiment shown in the drawings is shown to be concentric and continuous, obviously other types and forms of spacer flanges could be provided. The open top end 120 of the pipe 4 being capped through use of the sealable pressure cap 204. The sealable pressure cap 204 having an annular flange 212 extending downwards there from configured for connecting with the outside surface 5 of the riser pipe 4 through use of a suitable plumbing adhesive. While sealingly connecting with the outside portion is preferred, likewise the cap could connect with the inside portion of the open top end or even the rim of the open top end if so necessary.

The embodiment shown in FIG. 7, as well as the embodiment of FIG. 8 showing that the sealable pressure cap 204 has an internal annular flange 212 and an external annular flange 312. While this is the number shown in the drawings, obviously more or less annular flanges could exist, as deemed necessary. This pair of annular flanges allowing the single construction element having both the spacer sleeve 202 and the sealable pressure cap 204 to be used both on a first diameter of pipe (FIG. 7) and a second, larger diameter pipe (FIG. 8). Thus, with the larger pipe as shown in FIG. 8, it is the outer annular flange 312 which connects with and seals to the riser pipe 6. It is preferred likewise in this embodiment that the exterior portion 7 of the riser pipes 6 connects with and be sealed to the annular flange 312 of the sealable pressure cap 204. As indicated above, the other methods of sealing are likewise provided as discussed.

Still referring to FIG. 8, shown is the utilization of the spacer sleeve 202 on a larger pipe than what is shown in FIG. 7. The riser pipe 4 of FIG. 7 being of different outside diameter than the riser pipe 6 of FIG. 8. In one example, the riser pipe of FIG. 7 could be three-inches in diameter and the riser pipe of FIG. 8 could be four-inches in diameter. In such a utilization, as discussed above in the discussion related to FIGS. 4 and 5, the same spacer sleeve 202 could be used in both applications as well the same sealable pressure cap 204, merely needing a portion of the concentric spacer flange 214 to be knocked out, such as previously discussed with respect to the inner perforation 216, to thereby allow the spacer sleeve 202 to be used in a larger size of pipe. This combination, as shown in FIG. 8, resulting in a much smaller protective space 226 then what is shown in FIG. 7.

The present invention would be utilized by provision of the combination of pipe test cap and pipe concrete sleeve (construction elements). This combination of two elements connected together through use of the breakable connector as described above. In use, after the basic rough plumbing has been laid out upon and extending through the ground surface, the plumber would be next tasked with the job of pressure testing the system. To pressure test the system, all of the vertical riser pipes and other pipes need to be sealed shut so that the test can be performed. The plumber would take one of the construction elements and insert the open top end of a riser pipe into the lower end of the construction element, thereby sliding the spacer sleeve onto to the riser pipe. Once the open top end of the riser pipe extends out of the upper end of the spacer sleeve, a customary quantity of plumbing adhesive or other boding agent would be applied to one or both of the appropriate mating portions/surfaces of the sealable pressure cap and the riser pipe. Upon doing so, the sealable pressure cap would then be fitted to the riser pipe forming a sealed connection there between. The breakable connection between the sealable pressure cap and the spacer sleeve would be maintained through this process so that through the connection between the riser pipe and the sealable pressure cap that the spacer sleeve would be held above the ground surface. This being done so as to protect the spacer sleeve from damage and soiling while further construction takes place on the jobsite.

The plumber would then perform a pressure test to the system. If the system fails the pressure test, then the plumber would remedy the deficiencies to obtain satisfactory pressure test results. After doing so in the normal progression of construction time, the ground surface of the site would eventually be back filled, compacted, and fine graded as is typically done. Preferably after fine grading has taken place, the plumber and/or another construction worker would return to the installed construction elements and would twist, push, pull, cut or otherwise break the breakable connection between the spacer sleeve and the sealable pressure cap, thereby allowing the spacer sleeve the ability to slide down the riser pipe to rest upon the graded ground surface awaiting concrete slab pouring. Once the spacer sleeve is placed into position and thereby the pipe is “wrapped” the construction process could continue and the concrete slab could be poured around the spacer sleeve. Upon the hardening of the concrete slab, the sleeve has performed its function of providing the wrapper protection to the concrete sleeve extended above. Later in the construction process a plumber would return to the site where the spacer sleeve was installed and would cut or trim the piece of the riser pipe extending generally from the concrete slab upwards to the sealed cap for incorporation into the plumbing system as planned, for instance the pipe may be cut generally adjacent to the concrete slab so as to allow a closet flange to be installed or a plumbing fixture such as a sink maybe installed off of the riser pipe. In doing so, the plumber would come back and would likely cut off the portion of the riser pipe containing the sealable pressure cap. This cut off portion could be discarded or even could be reused in later pressure testing of the system at other fixtures or connection points.

In the following description and in the figures, like elements are identified with like reference numerals. The use of “or” indicates a non-exclusive alternative without limitation unless otherwise noted. The use of “including” means “including, but not limited to,” unless otherwise noted.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A construction element for use in testing and protecting a riser pipe, said riser pipe having a vertical portion extending above a ground surface, said vertical portion having a sidewall and terminating in an open top end, the riser pipe having an exterior surface, said construction element comprising:
a spacer sleeve for protecting a portion of said sidewall while a concrete slab is formed, said spacer sleeve generally tubular in shape, having an open first end and an open second end, said spacer sleeve defining a passageway there through defined by an interior surface, this passageway configured for slidingly receiving said riser pipe therein;
a sealable pressure cap for sealing the riser pipe's open top end; and
a connector connecting said sealable pressure cap to said spacer sleeve, said connector configured for breaking,
wherein, after the riser pipe capped by said sealable pressure cap is pressure tested, a user can break said connector, thereby detaching said spacer sleeve from said sealable cap and position said spacer sleeve for concrete slab formation there around.

2. The construction element of claim 1, wherein said spacer sleeve passageway comprises a concentric flange, said concentric flange defining an aperture there through generally the diameter of said riser pipe.

3. The construction element of claim 2, wherein said concentric flange comprises at least one perforation allowing a portion of said concentric flange to be removed.

4. The construction element of claim 3, wherein said portion is ring shaped.

5. The construction element of claim 3, wherein removal of said portion defines a closet flange space for allowing a closet flange to be installed on said riser pipe protected by said spacer sleeve.

6. The construction element of claim 1, wherein said spacer sleeve has a sidewall defining at least one perforation there through, allowing a portion of said sidewall to be torn off after installation.

7. The construction element of claim 1, wherein the space between the interior surface of the spacer sleeve and the exterior surface of the riser pipe defining a protective space for the protection of the riser pipe as the concrete slab expands.

8. The construction element of claim 1, wherein said sealable pressure cap comprises an annular flange configured for providing a sealing surface when the sealable pressure cap is sealed to said riser pipe open top end rim.

9. The construction element of claim 1, wherein said sealable pressure cap can be used to seal two different diameters of riser pipe, said cap comprising at least two concentric annular flanges.

10. The construction element of claim 9, wherein said at least two concentric annular flanges comprise:
an inner annular flange configured for providing a sealing surface when the sealable pressure cap is sealed to said riser pipe open top end rim; and
an outer annular flange configured for providing a sealing surface when the sealable pressure cap is sealed to said riser pipe open top end rim.

11. The construction element of claim 1, further comprising an adhesive for sealing said sealable pressure cap to said riser pipe rim.

12. The construction element of claim 1, where said connector comprises a strip of plastic having a first end adhered to the sealable pressure cap and a second end adhered to the spacer sleeve.

13. The construction element of claim 1, wherein said spacer sleeve remains connected to said sealable pressure cap via said connection while said sealable pressure cap is sealed to said riser pipe rim and remains so connected until after said riser pipe is pressure tested.

14. A construction element for use in testing and protecting a riser pipe, said riser pipe having a vertical portion extending above a ground surface, said vertical portion having a sidewall and terminating in an open top end, the riser pipe having an exterior surface, said construction element comprising:
a spacer sleeve for protecting a portion of said sidewall while a concrete slab is formed, said spacer sleeve generally tubular in shape, having an open first end and an open second end, said spacer sleeve defining a passageway there through defined by an interior surface, this passageway configured for slidingly receiving said riser pipe therein;
a sealable pressure cap for sealing the riser pipe's open top end, said sealable pressure cap comprising an annular flange configured for providing a sealing surface when the sealable pressure cap is sealed to said riser pipe open top end rim; and
a connector connecting said sealable pressure cap to said spacer sleeve, said connector configured for breaking,
wherein after the riser pipe capped by said sealable pressure cap is pressure tested a user can break said connector, thereby detaching said spacer sleeve from said sealable cap and positioning said spacer sleeve for concrete slab formation there around.

15. The construction element of claim 14, wherein said spacer sleeve passageway comprises a concentric flange, said concentric flange defining an aperture there-through generally the diameter of said riser pipe.

16. The construction element of claim 15, wherein said concentric flange comprises at least one perforation allowing a portion of said concentric flange to be removed.

17. The construction element of claim 14, wherein the space between the interior surface of the spacer sleeve and the exterior surface of the riser pipe defining a protective space for the protection of the riser pipe as the concrete slab expands.

18. The construction element of claim 14, wherein said sealable pressure cap can be used to seal two different diameters of riser pipe, said cap comprising at least two concentric annular flanges.

19. The construction element of claim 18, wherein said at least two concentric annular flanges comprise:
an inner annular flange configured for providing a sealing surface when the sealable pressure cap is sealed to said riser pipe open top end rim; and
an outer annular flange configured for providing a sealing surface when the sealable pressure cap is sealed to said riser pipe open top end rim.
